(19) United States
(12) Patent Application Publication
(10) Pub. No.: US 2007/0199070 A1
(43) Pub. Date: Aug. 23, 2007

(54) SYSTEMS AND METHODS FOR INTELLIGENT MONITORING AND RESPONSE TO NETWORK THREATS

(76) Inventor: William A. Hughes, Mankato, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/379,369

(22) Filed: Apr. 19, 2006

Related U.S. Application Data
(60) Provisional application No. 60/743,311, filed on Feb. 17, 2006.

(51) Int. Cl. G06F 12/14

(52) U.S. Cl. 726/23

(57) ABSTRACT

A network threat response engine creates order rules based on the real time study of the patterns and the subsequent behavior analysis of the security events in the network. The network threat response engine monitors the flow of communication streams, compiles statistics are compares these with the existing database(s) of vulnerabilities. Consequently, network threat response engine creates rules and policies that result in allowing, denying or trapping attempted intrusions into the network. Additionally, the systems described perform operations to initialize an isolated software environment which can respond to requests for services that are deemed to be threats to the network.

### RELATED APPLICATION

This application claims the benefit of U.S. Provisional Application Serial No. 60/743,311 filed Feb. 17, 2006, which application is incorporated herein by reference.

### TECHNICAL FIELD

This application relates to systems and methods of response to network threats and more particularly to systems and methods for the intelligent monitoring and response to network threats

### BACKGROUND

Operating an interconnected group of computers that has access to the internet at large presents many challenges. One of them is that of malicious attacks on the network. Another is the unintentional vulnerabilities and exposure to worms and viruses. Yet another is the ever-increasing volume of spam that all users receive in their email on a daily basis.

There are many methods of protecting a network that are currently in use. They typically consist of some gatekeeper device that provides a single point through which all network applications pass. Use of an example would more clearly show what is currently being used by computer network operators. In medieval times, the castle grounds were protected by a gate. All persons desiring access to the castle or wanting to travel out of the castle had to pass through the gate. At the gate, they could be questioned and searched determining if their activity was a threat to the king. Additionally, the king may have needed to operate a market that was open to all but under his control. Such a market could be set outside of the gate in a demilitarized zone (DMZ), preventing such operations from putting people inside the castle at risk. Both of these scenarios are in use today on computer networks, but the persons in this example are not network packets or network communications. But, just like the gatekeeper in the example, the gatekeeper on our computer network needs to be told what to do, what to look for, who to stop, and what to allow. The guard at the gate is not very flexible.

### BRIEF DESCRIPTION OF THE DRAWINGS

Embodiments are illustrated by way of example and not limitation in the figures of the accompanying drawings, in which like references indicate similar elements and in which:

FIG. 1 shows a high level block diagram of an apparatus for processing one or more network access attempts, in accordance with an example embodiment;

FIG. 2 shows a more detailed block diagram of an apparatus for processing one or more network access attempts, in accordance with an example embodiment;

FIG. 3 shows a more detailed block diagram of an apparatus for processing one or more network access attempts, in accordance with an example embodiment;

FIG. 4 shows a high level block diagram of a system of intelligent network monitoring and response, in accordance with an example embodiment;

FIG. 5 shows a flowchart of a method of monitoring and responding to one or more network access attempts, in accordance with an example embodiment;

FIG. 6 shows a flowchart of a method of responding to a malicious network access, in accordance with an example embodiment; and

FIG. 7 shows a block diagram of a machine including instructions to perform any one or more of the methodologies described herein.

### DETAILED DESCRIPTION

In the following detailed description of example embodiments, reference is made to the accompanying drawings which form a part hereof, and in which is shown, by way of illustration, specific embodiments in which the example method, apparatus and system may be practiced. It is to be understood that other embodiments may be utilized and structural changes may be made without departing from the scope of this description.

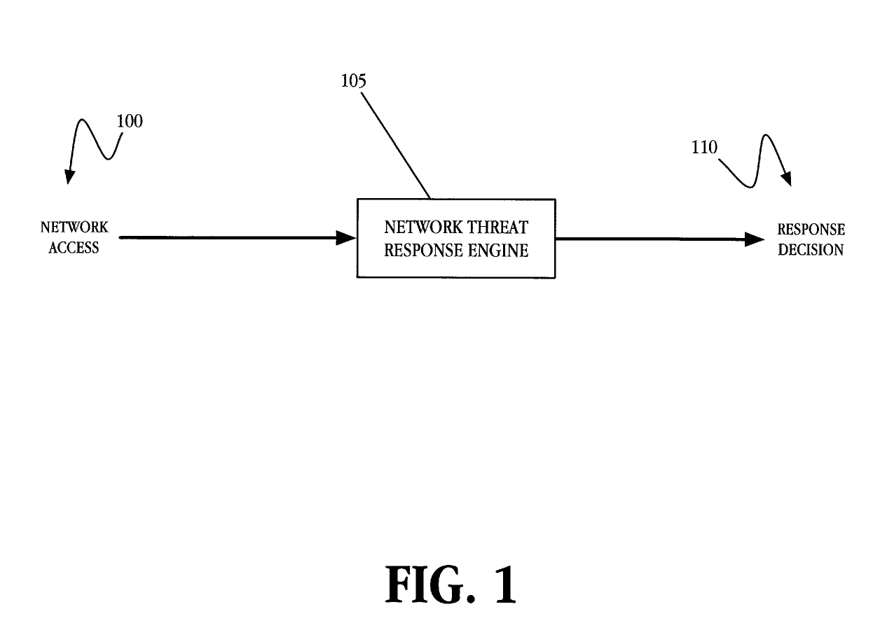

FIG. 1 shows a high level block diagram of an apparatus for processing one or more network access attempts, in accordance with an example embodiment. A network access 100 is shown as an input to a network threat response engine 105. The network threat response engine (NTRE) 105 processes one or more rules and performs one or more operations, in some examples, to determine if the network access 100 is a threat, and outputs a response decision 110. The response decision 110 may include, without limitation, allow, deny and initialize an isolated software environment to process the network access.

Network administrators face a larger variety of network threats than ever before. With the increasing number of viruses, and spam attacks, traditional network protection is already being stretched to the limit. These are passive attacks, however, and are not directed with particularity at a particular network installation. Active network attacks, such as a malicious attacker attempting to gain access to network resources present a second challenge to the network administrator. Network administrators, as a best practice, attempt to segregate their internal network from the public network through the use of firewall devices. These firewall devices act as a single point of control for the network. All network traffic will pass through the firewall device. The firewall device is configured by the network administrator to respond to known threats. The firewall device may additionally be configured to deny network connections that are troublesome, such as telnet or ssh access. However, in the case of an active attack, the network firewall may be unable to respond quickly enough.

In an embodiment, an NTRE 105 is deployed in parallel to the network firewall. In such an example, the network firewall is used as discussed above and is configured to respond to known threats. The NTRE 105 provides an additional, more complete, layer of protection. The NTRE 105, in one embodiment, receives network accesses in parallel with the network firewall and performs an analysis on those accesses to determine if a particular network access is a threat. The NTRE 105 is configured to analyze the network access with respect to known threats, in one example. In such an example, the NTRE 105 maintains a database of previously observed attacks. This may be pre-populated with attacks that have been observed at other locations, or through a service. The database may include separate collections of known attacks, such as virus attacks, worm attacks, spam attacks, phishing attacks, intrusion attacks, as well as unclassifiable network accesses that are outside a baseline.

In a further embodiment, the NTRE 105 is configured to operate in the absence of known network threats. In such an arrangement, a network baseline behavior is used when analyzing network accesses. The network baseline behavior provides the NTRE 105 a behavior that is considered normal or not a threat. Such behavior could include the network behavior of an email being received by a user, or a user accessing a web page, or a user receiving a streamed media file. In all of these examples, the behavior of such actions could be used as a baseline behavior to compare future accesses to the network. The NTRE 105 may be configured, in some examples, to operate alongside the network firewall during a learning period, where the NTRE 105 merely monitors the network traffic that is being handled by the network firewall, observing which network accesses are denied by the network firewall and which are allowed, and what the behavior of the allowed network access looks like. Following this learning period, the NTRE 105 may then provide an analysis on particular network accesses and a decision on how a particular network access is addressed. This may include, without limitation, allowing the network access, denying the network access, allowing the network access with further monitoring of those communications, or initializing an isolated software environment that is capable of responding to the network access and further related communications.

In one embodiment, the NTRE 105 is configured to not only monitor network accesses received from the outside devices, but is also configured to monitor network accesses of computing devices inside the network as they access resources outside the network. Examples of such operations include, without limitation, accessing a web site on the internet, communicating using Instant Message (IM) protocols, accessing BitTorrent file feeds, requesting streaming multimedia access, and the like.

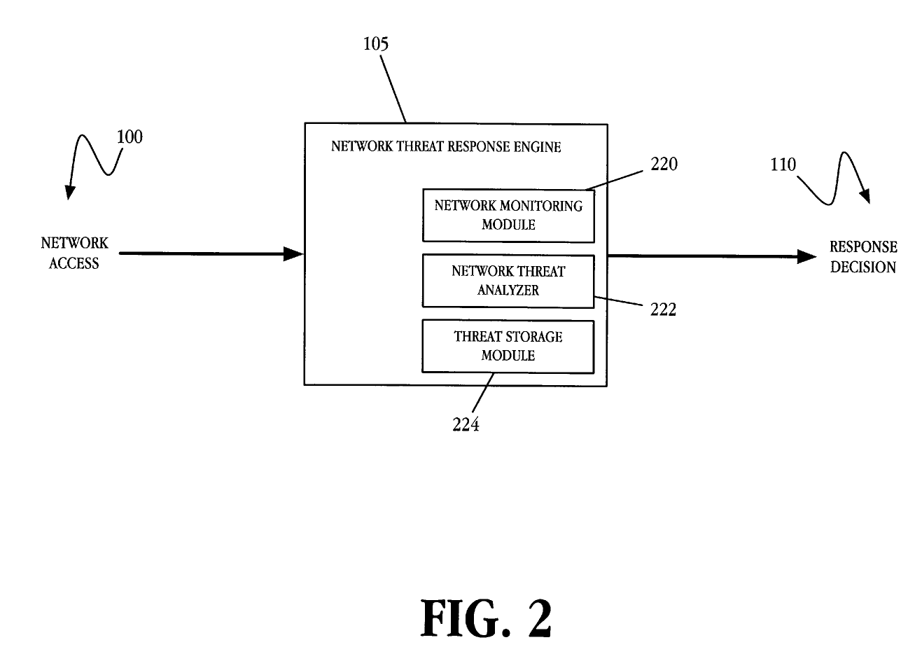

FIG. 2 shows a more detailed block diagram of an apparatus for processing one or more network access attempts, in accordance with an example embodiment. In one embodiment, the NTRE 105 depicted in FIG. 2 includes a network monitoring module 220, a network threat analyzer module 222 and a threat storage module 224.

In one embodiment, the network monitoring module 220 is configured to monitor all network traffic. The network traffic is received in parallel to a network device separate from the NTRE 105, in one example. In another example, the NTRE 105 is co-located with a network firewall. The network monitoring module 220 is configured to receive all network traffic, both incoming and outgoing. This is advantageous as one of the larger threats to network security, in practice, is not attackers attempting exploits from outside the network, but users inside the network, either intentionally or unintentionally, creating network insecurity. One example of such insecurity could be a user carrying a Universal Serial Bus (USB) flash memory device. The user, in this example, may wish to share photos of their latest vacation with co-workers. The USB flash memory device which contains the photos, may also contain a virus or worm that the user has on their home computer. By attaching this device to a computer in the network, the virus or worm may now be transferred to that computer and create insecurity inside the network. In the case of an intentional insecurity, the user in this example may have executable code on the memory device that can retrieve data on the inside of the network and transfer that data to a computer on the outside of the network.

In one embodiment, the network threat analyzer module 222 is configured to examine each of the unique communications streams and determine if any of them constitute a threat to the network. The network threat analyzer module 222 is configured to determine the pattern of the communications and compare the pattern to either known threat patterns, or to a baseline network access behavior to determine if that particular stream is a threat. The pattern of the communications in comparison to either known patterns (i.e. stored patterns), or normal patterns (i.e. baseline network access behavior) creates the first data point in determining whether a particular network communications stream is a threat to the network. The second data point is user-configurable rules, in an embodiment. The user-configurable rules can define, in some examples, the security level of a particular network segment. For example, in the case of a financial institution where data security needs are very high, the security level of that network segment is very high. Using the combination of the security level and the comparison of the pattern of particular communications streams to known or baselines will result in many particular communications streams being deemed threats. This is due, in large part, to the high security level. Typically, each unique communications stream will not exactly resemble a baseline network communications pattern, and even a small departure from that baseline network communications, in conjunction with a high security level will result in that particular stream being deemed a threat and dealt with as if it was an exploit or attack.

In alternate embodiments, the user configurable rules can be set at a very granular level and particular to the type of network traffic that is being observed. For example, email, web, file server, instant message, multimedia streaming, etc, can all be handled very differently. Typically, web server access by users inside the network typically does not represent as much of a potential threat as downloading attachments in an email. Each of these can be handled differently, with the latter's user-configurable rules being set much more restrictedly then the former.

In yet another embodiment, the network threat analyzer module 222 can employ other methods to determine if a particular network access is deemed to be a threat to the network. This may be advantageous, in particular to the early learning stages. In such an example, the network threat analyzer can use genetic-type programming to learn and better respond to network threats. Genetic programming uses the paradigm of natural selection to develop computer processes that better respond to various programming challenges. In the example of threat analysis and learning, processes and programs can be run which attempt to learn if a particular access is a threat. Processes and programs that perform better, either in speed or in accuracy, are given the opportunity to spawn more processes that can improve on them. Processes and programs that perform poorly are restricted in their replication, such that the better performing processes and programs spawn more new generations. Through this process, which mimics the theory of natural selection in evolutionary biology, and over many, many generations, very efficient and accurate analytical processes are generated. Actual genetic programming is outside the scope of the present discussion, and any suitable genetic programming method used in conjunction with network threat analysis can be used.

In a further embodiment, the network threat analyzer module 222 includes an external threat module (not shown in FIG. 2). The external threat module is configured to communicate with one or more external data stores, each of which contain uniquely descriptive information associated with one or more network threats. Each of the external data stores may be configured to store information about a particular type of network threat, such as spam, viruses, worms, or intrusion, or each of the external data stores may store information about more then one type of threat. In a further embodiment, the external data stores are maintained by a third party, that is an entity that is removed from the operation of the NTRE 105 and whose services are subscribed to by the operator of the NTRE 105. Through such an arrangement, the operator of the NTRE 105 can relieve themselves of the burden of continually updating the stored information about the types of network threats that they are concerned with.

In one embodiment, a threat storage module 224 is provided for the storage of network threats observed by the apparatus. This provides the network threat analyzer module 222 with a library of previous attacks to use in determining the presence of future attacks, in some examples. The threat storage module 224 is configured to receive the patterns of network accesses observed by the network threat analyzer, in one embodiment. In a further embodiment, the determination as to the degree or level of the threat of a particular pattern is also stored. For example, if a particular network access is compared to a known baseline network pattern and in conjunction with the user-configurable rules, it is determined that this particular access is not a threat, the actual pattern of the particular access can be stored in the threat storage module 224 as an example of allowable network accesses. Additionally, a network administrator can pre-load patterns of known attacks or exploits that have been previously been observed, either at that network or other networks. The network administrator, in this example, could obtain these patterns through any means suitable, such as direct communication with other network administrators and continually update the database of threats

In a further embodiment, the NTRE 105 additionally includes an external device liaison module (not shown in FIG. 2) that is configured to couple to a network device. The network device may include, without limitation, a network firewall configured to monitor network communications to and from the client network. The external device liaison module is further configured, in an embodiment, to send data items to the network device that are configured to cause the network device to perform one or more operations. The one or more operations include, without limitation, allowing a specific network connection, denying a particular network connection, or forwarding a particular network connection to a virtualized server device.

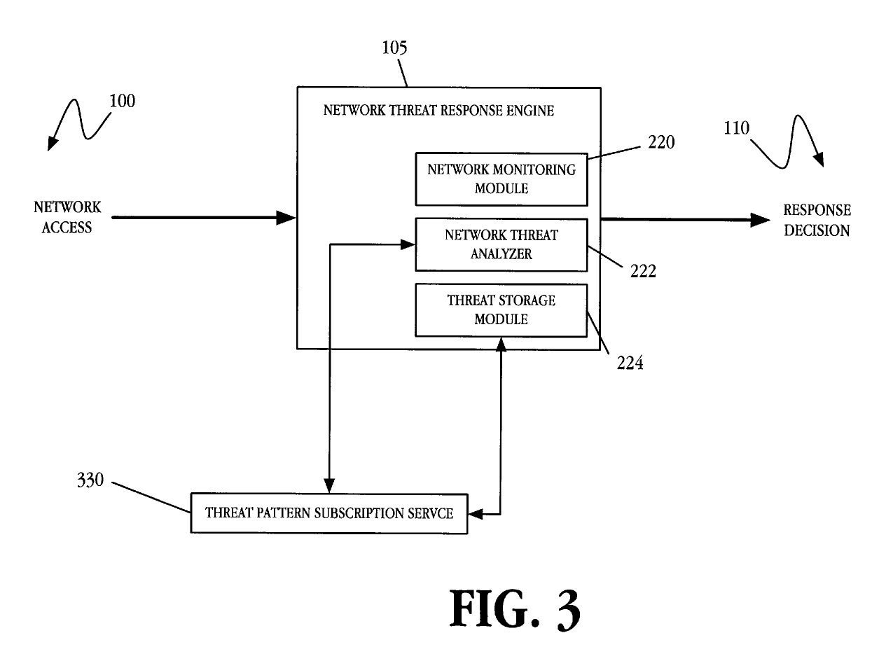

FIG. 3 shows a more detailed block diagram of an apparatus for processing one or more network access attempts, in accordance with an example embodiment. The apparatus depicted in FIG. 3 is similar to that depicted in FIG. 2 with the addition of a communicative connection to a threat pattern subscription service 330. This service is any third party provider which collects the patterns of observed network threats and provides that for a fee to network operators. Through the use of such a service, the network threat analyzer module 222 can make use of previously observed attacks to reach its decision.

In an embodiment, the network threat storage module 224 is configured to periodically poll the subscription service for newly observed threats. Such newly observed threat patterns are retrieved by the threat storage module 224 and stored in the database of threats. Future network accesses observed by the network monitoring module 220 and analyzed by the network threat analyzer module 222 that substantially match these newly observed threat patterns can be dealt with appropriately. In one example, a newly observed virus present in emails can quickly be added through this mechanism and thereby the network remains protected.

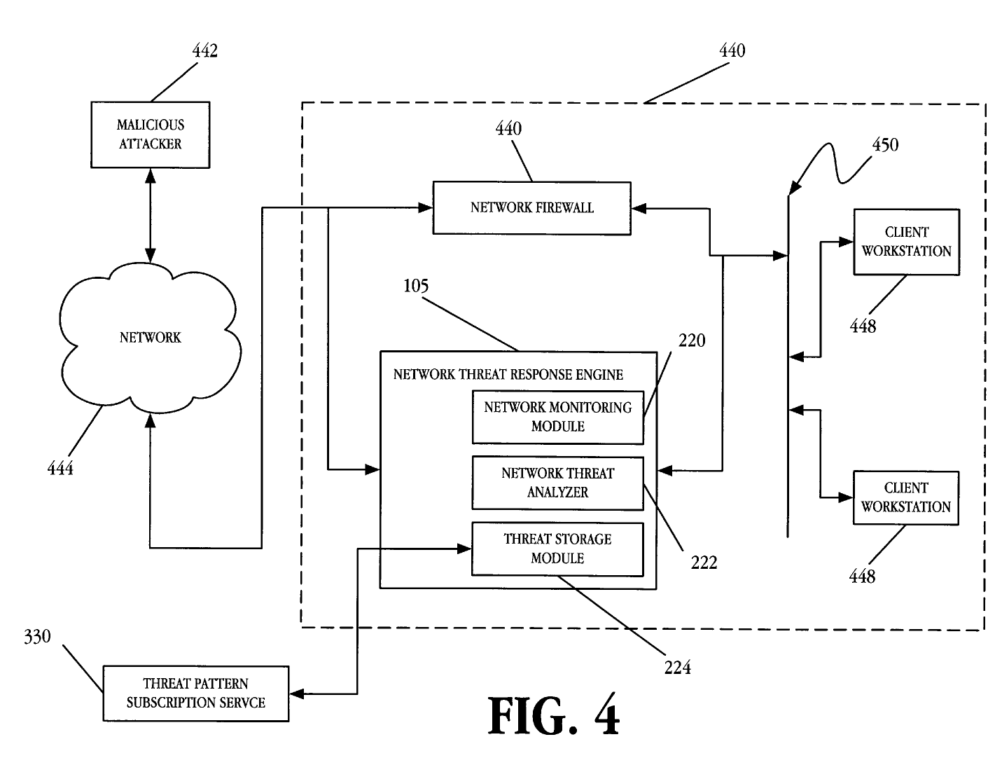

FIG. 4 shows a high level block diagram of a system of intelligent network monitoring and response, in accordance with an example embodiment. In one embodiment, the NTRE 105 operates in parallel with a network firewall 440. In an alternate embodiment, the NTRE 105 operates in parallel with a network device. The network device may include, without limitation, firewall, router, switches, hubs, wireless access points and the like. In a further embodiment, the NTRE 105 is communicatively coupled to the network device and is capable of sending instructions to the network device, the instructions configured to cause the network device to perform operations to allow or deny future network communications that are deemed to be a threat to the network.

In an embodiment, a malicious attacker 442 exists. In this example, the malicious attacker 442 desires to intentionally disrupt the user network 444 or to exploit a vulnerability on the user network 444 for any reason. The user network 444 is protected by the network firewall 440. However, the network firewall 440 is limited in its ability to protect the user network 444. The network firewall 440 is only capable of watching connections as they occur and determine based on existing configuration files whether to allow or deny a particular network access. For one example, the network firewall 440 may protect a web server that is accessible to the network 444. The network firewall 440 is configured to pass all IP traffic addressed on port 80. A malicious attacker 442 may choose to exploit that weakness. Typically, in normal network operations, publicly accessible servers are located in what is known in the art as a DMZ (demilitarized zone). Servers located in the DMZ are still physically located in the user network, but typically have no direct network connection to devices on the inside of the user network, such as the client workstations 448. However, the servers in the DMZ do typically have access to resources on the user network, such as the network firewall 440. A malicious attacker 442 may choose to exploit that access to gain further access to unprotected services located in the user network 444.

The client workstations 448 on the user network 444 are interconnected to other client workstations 448 over an ethernet network 450, in one example. In another example, client workstations 448 are connected to the user network over a wireless connection. In a further example, the client workstations 448 are connected to the user network through other suitable means. Client workstations 448 may include, without limitation, desktop computers, laptop computers, portable computers, personal digital assistants, terminal computers, server computers, and the like. Additionally, the client workstations 448 may represent further subdivisions of the user network, such that more networks can be accessed through them. One example, meant only as illustrative, is that of a widely distributed corporate network. The corporate network may have one single point of access to other networks, while individual devices on the corporate network provide a point of access to individual business units. A building, for example, may contain many user computing devices, each of which is connected to the corporate network through a network routing device. The network routing device, along with the NTRE 105 described above, can monitor all traffic coming into and out of the building. Each of the buildings on a corporate campus is in turn, connected to a corporate network routing device. This corporate network routing device provides access to the internet at large. However, all network traffic to and from each of the buildings must pass through this corporate network routing device. In parallel with this corporate network routing device, may be a corporate network threat response engine, substantially similar to the NTRE 105 described above with respect to FIG. 1. This type of system would allow many multiple layers of protection for individual computing devices at the building, but also allows for the corporate network administrator to finely control the degree of security on each of these network segments.

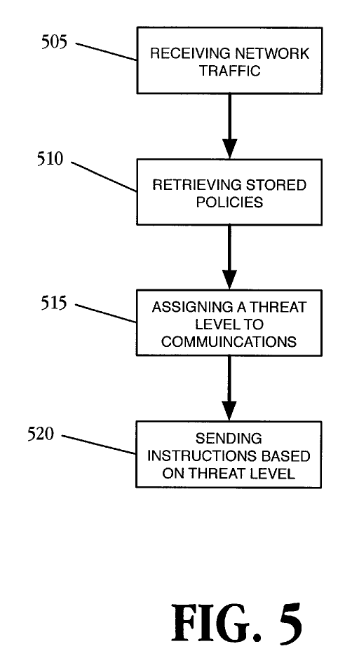

FIG. 5 shows a flowchart of a method of monitoring and responding to one or more network access attempts, in accordance with an example embodiment. In one embodiment, the operations depicted in FIG. 5 and described here are carried out on a NTRE 105 as depicted and described above.

At block 505, network traffic is received. In one embodiment, the network traffic is received at a NTRE 105 in parallel with a network device. The network device may include, without limitation, a firewall, router, server, switch, hub, wireless access point, or data port. In an alternate embodiment, the network traffic is received by the NTRE 105, analyzed by the NTRE 105 and then passed to the network device. In another embodiment, the network traffic is received by the network device and passed to the NTRE 105.

At block 510, the NTRE 105 retrieves one or more stored policies. Stored policies include, without limitation, user-configurable rules for threat response, user-defined security levels, user-defined security policies (e.g., no access to multi-media streaming service, or no access on a pre-defined port), and the like. At block 515, a threat level is assigned to communications contained within the network traffic. As is well-known, network traffic received by any network device consists of one or more unique communications. The NTRE 105 is configured to discriminate unique communications contained within the network traffic using any suitable method as is well known in the art. In order to assign a threat level to each of the unique communications, the NTRE 105 compares the pattern of that communications to known or baseline patterns, and applies the retrieved policy. Through such a combination of analysis and policy, response to particular network threats can be tailored appropriately. One example is web access. The web access may include the downloading of files, which are controlled very tightly by the network administrator, in this example. The policy would be very restrictive, and unless the particular access matched very closely an allowable communication, that particular communication could be denied.

At block 520, instructions are sent based on the assigned threat level. The instructions may include, without limitation, allowing the unique communication, denying the unique communication or allowing the unique communication but re-directing that communication to a software process specifically designed to respond to suspect communications. The instructions are configured at the NTRE 105 and are intended to cause the network device to perform the steps of allowing or denying the unique communication.

An example of FIG. 5 in operation can be made. An unknown computer over the intemet wishes to make a communicative connection to a file server contained in a network protected by a network firewall 440 and a NTRE 105 operating in parallel to the network firewall 440. The communications are monitored by the NTRE 105 and are compared to known patterns of communication. For the purpose of this example, the communications from that computer are for a file sharing connection to the file server. The policies stored by the NTRE 105 state that any file sharing connection is highly restricted. As this particular connection is coming from an unknown computer, and the policy is to highly restrict this type of connection, the connection in this case is denied. Alternatively, if the unknown computer was in fact known, say another corporate device located at another location, the pattern of the communication would be known and would be allowed, even in light of the highly restrictive nature of the communication.

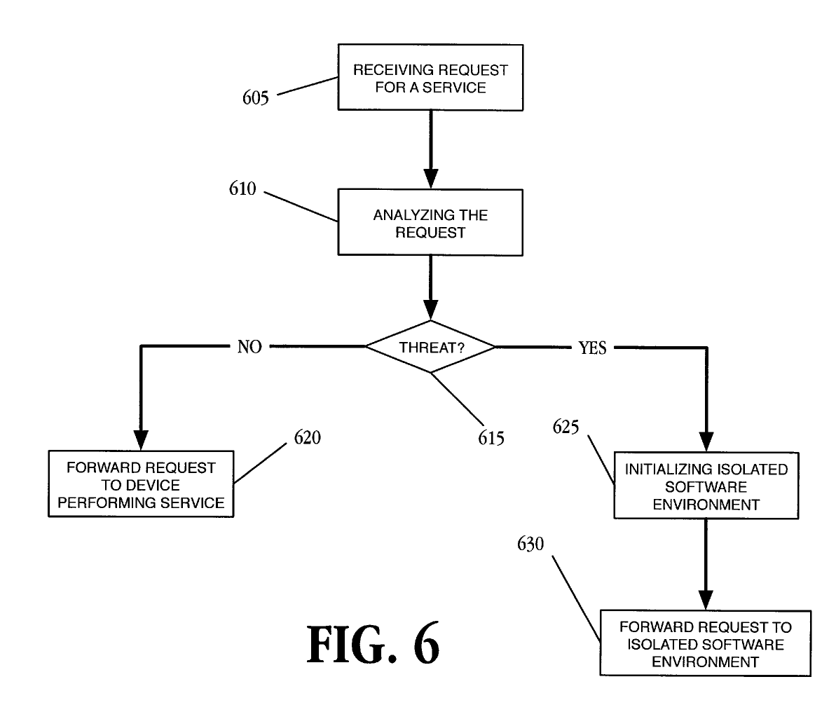

FIG. 6 shows a flowchart of a method of responding to a malicious network access, in accordance with an example embodiment. In one embodiment, the operations depicted in FIG. 6 and described here are carried out on a NTRE 105 as depicted and described above. In a further embodiment, some of the operations depicted in FIG. 6 are performed following a determination of the threat level of a particular network communications. In such an example, some of the operations described here may modify the allow/deny decision described above, and may represent a third category of response, allow/compartmentalize.

At block 605 a request for services is received. As discussed above, the request for services is a unique network communications contained within a plurality of network communications, or network traffic. The request for services includes any network communication that could generate a response from one or more network devices contained within the network protected by the NTRE 105. This is not meant to be limiting, and in its broadest interpretation, a request for services may include a single network packet received by the NTRE 105.

At block 610, the NTRE 105 analyzes the request, as discussed above. At block 615, the NTRE 105 determines if the request is a threat to the network or not. Expanding on the allow/deny response described above, if the request is determined not to be a threat, it is allowed and the request is forwarded to the appropriate device at block 620. However, the operations depicted with respect to FIG. 6 following a determination that the request is a threat, modify the deny decision significantly. If the request is determined to be a threat at block 615, the NTRE 105 can respond by allowing the request to be received, but not by the service requested. In this response, the NTRE 105 initializes an isolated software environment at block 625. The isolated software environment is a virtualized computing device executed on any suitable computing device and is capable of responding to network communications as if it were a physical computing device. Further, with respect to the present discussion, the isolated software environment executes at least some of the processes running on the computing device that was addressed in the request determined to be a threat. For example, the request is a request for web services, which would typically be addressed to a web server. The isolated software environment would emulate that device and be able to respond to at least requests for web services. In a further embodiment, the isolated software environment is additionally able to respond to requests for services other then the initial request for service. In one embodiment, the isolated software environment is executed on the same device as the NTRE 105. In an alternate embodiment, the isolated software environment is executed on a computing device in a network segment isolated from client workstations, such as the client workstations 448 in FIG. 4. In such an arrangement, compromise of the isolated software environment would not compromise the entirety of the network. In yet another embodiment, the isolated software environment is executed within the network device that is in parallel to the NTRE 105. In all examples, the isolated software environment provides an advantageous alternative to that of what is known in the art as a honeypot. A honeypot is a computing device executing false processes. Though a honeypot can be one aspect of protecting a network, the nature of a honeypot is that it is a configured device operating outside the network, or inside the network. However, the nature of a pre-configured device makes it unlikely that the honeypot will truly emulate the exact services that are being sought by the request. It is also very possible that the honeypot may become compromised as well. In any regard, the honeypot is able to intelligently respond to the request as if it was the device to which the initial request was directed.

Other methods of responding to requests that are deemed to be threats create delays in response to the initial request which can be measured by the attacker. Such delays indicate to the attacker that their communications are being monitored and stored. The attacker will likely turn their attention to other targets quickly, removing the ability to gather enough information to identify and prosecute the attacker. In the example of the isolated software environment, the device responds as if it were the service, so that there is no delay that is identifiable to the attacker. The request and subsequent communications can be stored in real-time and a forensic log of activity can be stored and used at a later time for criminal prosecution or civil action.

At block 630, the request determined to be a threat at block 615 is forwarded to the isolated software environment. Additionally, all future communications related to the request can be forwarded to the isolated software environment, in an embodiment. Communications may be related to the request in any suitable method, such as nature of the request or communication, address of the requesting entity, and the like. In such an example, the initial request and future communications related to it can be stored on any suitable storage mechanism and used at a later time.

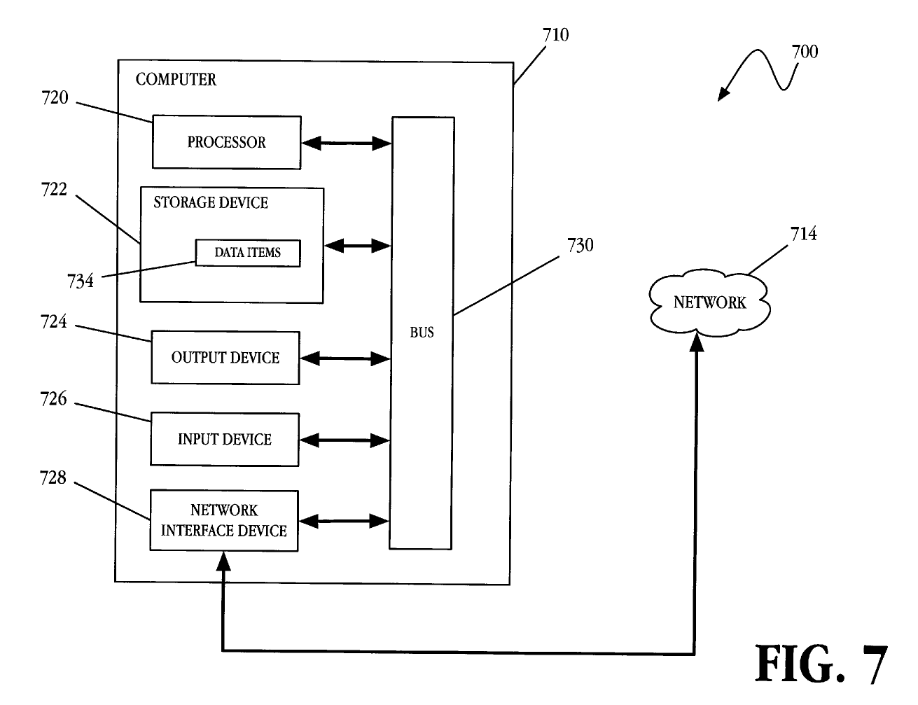

FIG. 7 shows a block diagram of a machine including instructions to perform any one or more of the methodologies described herein. A system 700 includes a computer 710 connected to a network 714. The computer 710 includes a processor 720, a storage device 722, an output device 724, an input device 726, and a network interface device 728, all connected via a bus 730. The processor 720 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 720 executes instructions and includes that portion of the computer 710 that controls the operation of the entire computer. Although not depicted in FIG. 6, the processor 720 typically includes a control unit that organizes data and program storage in memory and transfers data and other information between the various parts of the computer 710. The processor 720 receives input data from the input device 726 and the network 714, reads and stores code and data in the storage device 722, and presents data to the output device 724.

Although the computer 710 shows only a single processor 720 and a single bus 730, the present invention applies equally to computers that may have multiple processors, and to computers that may have multiple busses with some or all performing different functions in different ways.

The storage device 722 represents one or more mechanisms for storing data. For example, in an embodiment, the storage device 722 includes one or more memory devices such as, read only memory (ROM), random access memory (RAM), magnetic disk storage media, optical storage media, flash memory devices, and/or other machine-readable media. In other embodiments, any appropriate type of storage device may be used. Although only one storage device 722 is shown, multiple storage devices and multiple types of storage devices may be present. Further, although the computer 710 is drawn to contain the storage device 722, it may be distributed across other computers, for example on a server.

The storage device 722 includes a controller (not shown) and data items 734. The controller includes instructions capable of being executed on the processor 720 to carry out the functions of the present invention, as previously described above. In another embodiment, some or all of the functions of the present invention are carried out via hardware in lieu of a processor-based system. In one embodiment, the controller is a web browser, but in other embodiments, the controller may be a database system, a file system, or may include any other functions capable of accessing data items. Of course, the storage device 722 may also contain additional software and data (not shown), which is not necessary to understanding the invention.

Although the controller and the data items 734 are shown to be within the storage device 722 in the computer 710, some or all of them may be distributed across other systems, for example on a server and accessed via the network 714

The output device 724 is that part of the computer 710 that displays output to the user. The output device 724 may be a liquid crystal display (LCD) well-known in the art of computer hardware. But, in other embodiments the output device 724 may be replaced with a gas or plasma-based flat-panel display or a traditional cathode-ray tube (CRT) display. In still other embodiments, any appropriate display device may be used. Although only one output device 724 is shown, in other embodiments any number of output devices of different types, or of the same type, may be present. In an embodiment, the output device 724 displays a user interface.

The input device 726 may be a keyboard, mouse or other pointing device, trackball, touchpad, touch screen, keypad, microphone, voice recognition device, or any other appropriate mechanism for the user to input data to the computer 710 and manipulate a user interface. Although only one input device 726 is shown, in another embodiment any number and type of input devices may be present.

The network interface device 728 provides connectivity from the computer 710 to the network 714 through any suitable communications protocol. The network interface device 728 sends and receives data items from the network 714.

The bus 730 may represent one or more busses, e.g., USB (Universal Serial Bus), PCI, ISA (Industry Standard Architecture), X-Bus, EISA (Extended Industry Standard Architecture), or any other appropriate bus and/or bridge (also called a bus controller).

The computer 710 may be implemented using any suitable hardware and/or software, such as a personal computer or other electronic computing device. Portable computers, laptop or notebook computers, PDAs (Personal Digital Assistants), pocket computers, appliances, telephones, and mainframe computers are examples of other possible configurations of the computer 710. For example, other peripheral devices such as audio adapters or chip programming devices, such as EPROM (Erasable Programmable Read-Only Memory) programming devices may be used in addition to, or in place of, the hardware already depicted.

The network 714 may be any suitable network and may support any appropriate protocol suitable for communication to the computer 710. In an embodiment, the network 714 may support wireless communications. In another embodiment, the network 714 may support hard-wired communications, such as a telephone line or cable. In another embodiment, the network 714 may support the Ethernet IEEE (Institute of Electrical and Electronics Engineers) 802.3x specification. In another embodiment, the network 714 may be the Internet and may support IP (Internet Protocol). In another embodiment, the network 714 may be a local area network (LAN) or a wide area network (WAN). In another embodiment, the network 714 may be a hotspot service provider network. In another embodiment, the network 714 may be an intranet. In another embodiment, the network 714 may be a GPRS (General Packet Radio Service) network. In another embodiment, the network 714 may be any appropriate cellular data network or cell-based radio network technology. In another embodiment, the network 714 may be an IEEE 802.11 wireless network. In still another embodiment, the network 714 may be any suitable network or combination of networks. Although one network 714 is shown, in other embodiments any number of networks (of the same or different types) may be present.

The embodiments described herein may be implemented in an operating environment comprising software installed on any programmable device, in hardware, or in a combination of software and hardware.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. An apparatus for intelligent network threat response, the apparatus comprising:
a network monitoring module to capture network traffic in parallel with a network device;
a network threat analyzer to analyze the captured network traffic and to identify one or more network threats based on the analysis; and
a threat storage module to store uniquely descriptive information associated with the one or more network threats.

2. The apparatus of claim 1, further comprising:
an external device liaison module to couple to the network device and to send data items to the network device, the data items configured to cause the network device to perform operations intended to deny one or more network connections.

3. The apparatus of claim 1, wherein the network threat analyzer includes an external threat module, the external threat module to communicate with external data stores, the external data stores containing uniquely descriptive information associated with network threats, the network threats including at least one of the following: spam threats, virus threats, or intrusion threats.

4. The apparatus of claim 1, wherein the network threat analyzer is to analyze using a behavioral comparison analysis.

5. The apparatus of claim 1, wherein the network threat analyzer is to analyze the one or more network threats using genetic-type programming and algorithms.

6. A system for intelligent network threat analysis, the system comprising:
a network device;
a network threat response engine coupled to the network device, the network threat analyzer including:
a network monitoring module to capture network traffic in parallel with the network device;
a network threat analyzer to analyze the captured network traffic and to identify one or more network threats based on the analysis; and
a threat storage module to store uniquely descriptive information associated with the one or more network threats.

7. The system of claim 6, wherein the at least one network threat includes at least one of the following threat types: spam, virus, or intrusion.

8. The system of claim 6, wherein network device includes at least one of the following device types: router, switch, or wireless access point.

9. The system of claim 6, wherein the at least one known network threat is stored on a centralized data store.

10. The system of claim 6, wherein responding includes at least one of the following: denying the network connection, allowing the network connection with further watching, or trapping the network connection.

11. The system of claim 10, wherein denying the network connection includes sending a data item to the network device, the data item configured to cause the network device to perform operations intended to cease the network connection.

12. A method of dynamically responding to network threats, the method comprising:
receiving network traffic in parallel with a network device, the network traffic containing a plurality of unique network communications;
retrieving stored policies and analyzing each of the plurality of unique network communications using at least the stored policies;
assigning a threat level to each of the plurality of unique network communications based on the analysis; and
sending instructions to the network device, the instructions intended to cause the network device to allow or deny ones of the plurality of unique network communications.

13. The method of claim 12, wherein the plurality of unique network communications are additionally analyzed in comparison to one or more baseline network behaviors.

14. The method of claim 12, wherein the plurality of unique network communications are additionally analyzed in comparison to threat behaviors retrieved from a centralized data store, the threat behaviors corresponding to previously observed network threats.

15. The method of claim 12, wherein the at least one network threat includes at least one of the following threat types: spam, virus, or intrusion.

16. The method of claim 12, wherein network device includes at least one of the following device types: router, switch, or wireless access point.

17. The method of claim 12, wherein the at least one known network threat is stored on a centralized data store.

18. The method of claim 12, wherein responding includes at least one of the following: denying the network connection, allowing the network connection with further watching, or trapping the network connection.

19. The method of claim 18, wherein denying the network connection includes sending a data item to the network device, the data item configured to cause the network device to perform operations intended to cease the network connection.

20. A method of dynamically responding to threat vectors to networks, the method comprising:
receiving a request for services across a network;
analyzing the request to determine if the request is a threat;
initializing an isolated software environment, the isolated software environment to execute one or more software services, at least one of which is the service requested; and
forwarding the request and future communications related to the request to the isolated software environment.

21. The method of claim 20, wherein the request is received at a network threat analyzer in parallel to a network device.

22. The method of claim 21, wherein the network device is a firewall.

23. The method of claim 21, wherein the isolated software environment is a virtualized computing device executed on any suitable computing device and is configured to respond to network communications as a physical computing device.

24. The method of claim 23, wherein the isolated software environment is executed on the network device.

25. The method of claim 23, wherein the isolated software environment is executed on a computing device located on a network segment that is isolated from client workstations.
